(19) United States
(12) Patent Application Publication
(10) Pub. No.: US 2011/0316415 A1
(43) Pub. Date: Dec. 29, 2011

(54) PLASMA DISPLAY PANEL

(76) Inventors: Kaname Mizokami, Kyoto (JP); Shinichiro Ishino, Osaka (JP); Koyo Sakamoto, Osaka (JP); Yuichiro Miyamae, Osaka (JP); Yoshinao Ooe, Kyoto (JP)

(21) Appl. No.: 12/526,810

(22) PCT Filed: Apr. 1, 2009
(86) PCT No.: PCT/JP09/01522

§ 371 Date: Aug. 12, 2009

(30) Foreign Application Priority Data
Apr. 4, 2008 (JP) 2008-097911

(51) Int. Cl. H01J 17/49

(52) U.S. Cl. 313/587

(57) ABSTRACT

A plasma display panel is formed of front panel (2) and rear panel (10). Front panel (2) includes glass substrate (3) on which display electrodes (6) are formed, dielectric layer (8) covering display electrodes (6), and protective layer (9) formed on dielectric layer (8). Rear panel (10) confronts front panel (2) to form discharge space (16) therebetween, and includes address electrodes (12) formed along a direction intersecting with display electrodes (6), and barrier ribs (14) for partitioning discharge space (16). Protective layer (9) includes primary film (91) on dielectric layer (8), and aggregated particles (92) formed of multiple crystal particles made by firing a precursor of metal oxide and aggregating themselves together. Aggregated particles (92) are distributed and attached on the entire surface of primary film (91).

### TECHNICAL FIELD

The present invention relates to a plasma display panel to be used in a display device.

### BACKGROUND ART

A plasma display panel (hereinafter referred to simply as a PDP) allows achieving a high definition display and a large-size screen, so that television receivers (TV) with a large screen having as large as 100 inches diagonal length can be commercialized by using the PDP. In recent years, use of the PDP in high-definition TVs, which need more than doubled scanning lines comparing with the number of scanning lines needed for NTSC method, has progressed and the PDP free from lead (Pb) has been required in order to contribute to environment protection.

The PDP is basically formed of a front panel and a rear panel. The front panel comprises the following structural elements:
a glass substrate made of sodium-borosilicate-based float glass;
display electrodes, formed of striped transparent electrodes and bus electrodes, formed on a principal surface of the glass substrate,
a dielectric layer covering the display electrodes and working as a capacitor; and
a protective layer made of magnesium oxide (MgO) and formed on the dielectric layer.

The rear panel comprises the following structural elements:
a glass substrate;
striped address electrodes formed on a principal surface of the glass substrate,
a primary dielectric layer covering the address electrodes;
barrier ribs formed on the primary dielectric layer; and
phosphor layers formed between the respective barrier ribs and emitting light in red, green, and blue respectively.

The front panel confronts the rear panel such that its electrode-mounted surface confronts an electrode-mounted surface of the rear panel, and peripheries of both the panels are sealed in an airtight manner to form a discharge space therebetween, and the discharge space is partitioned by the barrier ribs. The discharge space is filled with discharge gas of Neon (Ne) and Xenon (Xe) at a pressure ranging from 5.3×104 Pa to 8.0×104 Pa. The PDP allows displaying a color video through this method: Voltages of video signals are selectively applied to the display electrodes for discharging, thereby producing ultra-violet rays, which excite the respective phosphor layers, so that colors in red, green, and blue are emitted, thereby achieving the display of a color video (Refer to Patent Document 1).

The protective layer formed on the dielectric layer of the front panel of the foregoing PDP is expected to carry out the two major functions: (1) protecting the dielectric layer from ion impact caused by the discharge, and (2) emitting primary electrons for generating address discharges. The protection of the dielectric layer from the ion impact plays an important role for preventing a discharge voltage from rising, and the emission of primary electrons for generating the address discharges also plays an important role for eliminating a miss in the address discharges because the miss causes flickers on videos.

To reduce the flickers on videos, the number of primary electrons emitted from the protective layer should be increased. For this purpose, impurities are added to MgO or particles of MgO are formed on the protective layer made of MgO. These instances are disclosed in, e.g. Patent Documents 2, 3, 4.

In recent years, the number of high-definition TV receivers has increased, which requires the PDP to be manufactured at a lower cost, to consume a lower power, and to be a full HD (high-definition, 1920×1080 pixels, and progressive display) with a higher brightness. The characteristics of emitting electrons from the protective layer determine the picture quality, so that it is vital for controlling the electron emission characteristics.

A protective layer added with a mixture of impurities has been tested whether or not this addition can improve the electron-emission characteristics; however, when the characteristics can be improved, electric charges are stored on the surface of the protective layer. If the stored electric charges are used as a memory function, the number of electric charges decreases greatly with time, i.e. an attenuation rate becomes greater. To overcome this attenuation, a measure is needed such as increment in an applied voltage. The protective layer thus should have two contradictory characteristics, i.e. one is a high emission of electrons, and the other one is a smaller attenuation rate for a memory function, namely, a high retention of electric charges.
Patent Document 1: Unexamined Japanese Patent Publication No. 2007-48733
Patent Document 2: Unexamined Japanese Patent Publication No. 2002-260535
Patent Document 3: Unexamined Japanese Patent Publication No. H11-339665
Patent Document 4: Unexamined Japanese Patent Publication No. 2006-59779

### DISCLOSURE OF INVENTION

The PDP of the present invention comprises the following structural elements:
a front panel including a substrate on which display electrodes are formed, a dielectric layer covering the display electrodes, and a protective layer formed on the dielectric layer; and
a rear panel opposing to the front panel to form a discharge space therebetween, and including address electrodes formed along the direction intersecting with the display electrodes, and barrier ribs for partitioning the discharge space. The protective layer includes a primary film formed on the dielectric layer, and aggregated particles each of which is formed of several crystal particles aggregated together. The aggregated particles are attached to the primary film such that they are distributed on the entire surface of the primary film. The crystal particles are made by firing a precursor of metal oxide.

The structure discussed above allows providing a PDP that can improve both of the electron emission characteristics and the electric charge retention characteristics of its protective layer, so that this PDP can be manufactured at a lower cost, display a quality picture at a lower voltage. The PDP having display performance of high definition and high brightness with less power consumption is thus obtainable.

### BRIEF DESCRIPTION OF DRAWINGS

FIG. 1 shows a perspective view illustrating a structure of a PDP in accordance with an embodiment of the present invention.

FIG. 2 shows a sectional view illustrating a structure of a front panel of the PDP.

FIG. 3 shows a sectional view detailing a protective layer of the PDP.

FIG. 4 shows a flowchart illustrating a method of manufacturing the protective layer of the PDP in accordance with the embodiment of the present invention.

FIG. 5 details aggregated particle 92.

FIG. 6 shows a result of measuring the cathode luminescence of crystal particles.

FIG. 7 shows a result of studying the relation between characteristics of electron emission and characteristics of Vscn lighting voltage.

FIG. 8 shows a relation between a diameter of a crystal particle and the electron emission characteristics of the PDP.

FIG. 9 shows a relation between a diameter of a crystal particle and a rate of occurrence of breakage in barrier ribs of the PDP.

FIG. 10 shows an example of particle size distribution of the aggregated particle of the PDP.

### DESCRIPTION OF REFERENCE MARKS

1 PDP
2 front panel
3 front glass substrate
4 scan electrode
4a, 5a transparent electrode
4b, 5b metal bus electrode
5 sustain electrode
6 display electrode
7 black stripe (lightproof layer)
8 dielectric layer
9 protective layer
10 rear panel
11 rear glass substrate
12 address electrode
13 primary dielectric layer
14 barrier rib
15 phosphor layer
16 discharge space
81 first dielectric layer
82 second dielectric layer
91 primary film
92 aggregated particle
92a crystal particle

### BEST MODE FOR CARRYING OUT THE INVENTION

An exemplary embodiment of the present invention is demonstrated hereinafter with reference to the accompanying drawings.

### Exemplary Embodiment

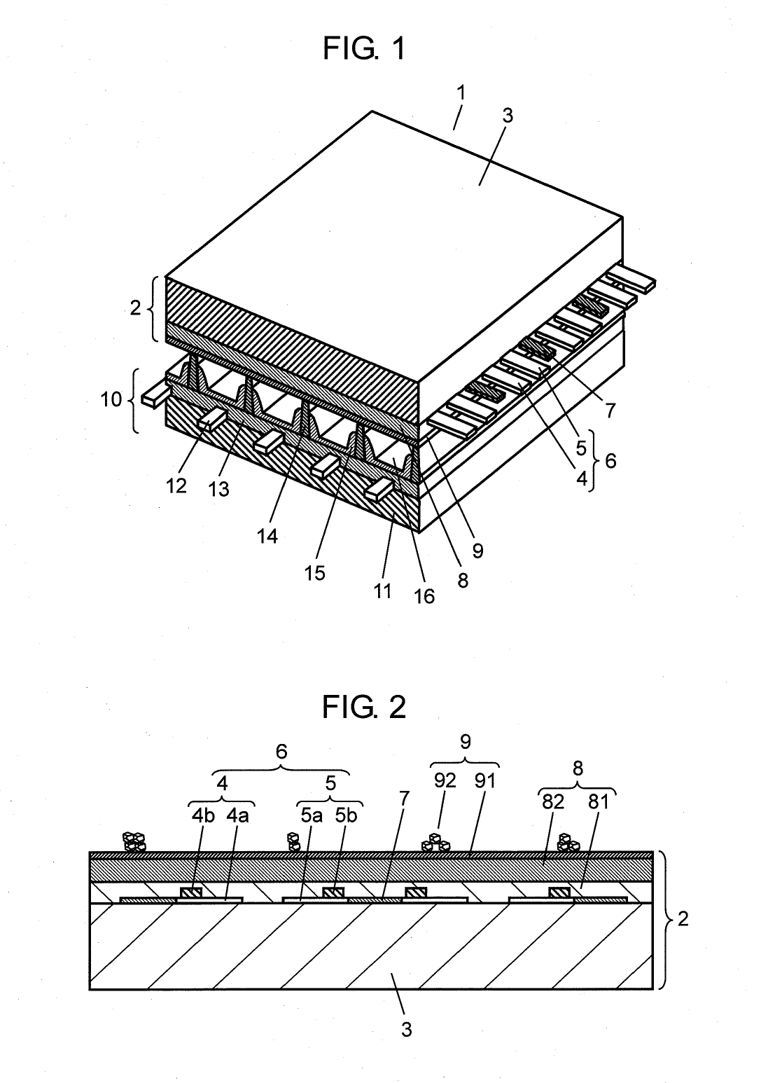

FIG. 1 shows a perspective view illustrating a structure of the PDP in accordance with the embodiment of the present invention. The PDP is basically structured similarly to a PDP of AC surface discharge type generally used. As shown in FIG. 1, PDP 1 is formed of front panel 2, which includes front glass substrate 3, and rear panel 10, which includes rear glass substrate 11. Front panel 2 and rear panel 10 confront each other and the peripheries thereof are airtightly sealed with sealing agent such as glass frit, thereby forming discharge space 16, which is filled with discharge gas of Ne and Xe at a pressure falling within a range between 5.3×104 Pa and 8.0×104 Pa.

Multiple pairs of belt-like display electrodes 6, each of which is formed of scan electrode 4 and sustain electrode 5, are placed in parallel with multiple black-stripes (lightproof layers) 7 on front glass substrate 3 of front panel 2. Dielectric layer 8 working as a capacitor is formed on front glass substrate 3 such that layer 8 can cover display electrodes 6 and lightproof layers 7. On top of that, protective layer 9 made of magnesium oxide (MgO) is formed on the surface of dielectric layer 8.

Multiple belt-like address electrodes 12 are placed in parallel with one another on rear glass substrate 11 of rear panel 10, and they are placed along a direction intersecting at right angles with scan electrodes 4 and sustain electrodes 5 formed on front panel 2. Primary dielectric layer 13 covers those address electrodes 12. Barrier ribs 14 having a given height are formed on primary dielectric layer 13 placed between respective address electrodes 12, and barrier ribs 14 partition discharge space 16. Phosphor layers 15 are applied sequentially in response to respective address electrodes 12 onto grooves formed between each one of barrier ribs 14. Phosphor layers 15 emit light in red, blue, and green with an ultraviolet ray respectively. A discharge cell is formed at a junction point where scan electrode 14, sustain electrode 15 and address electrode 12 intersect with one another. The discharge cells having phosphor layers 15 of red, blue, and green respectively are placed along display electrodes 6, and these cells work as pixels for color display.

FIG. 2 shows a sectional view illustrating a structure of front panel 2 of the PDP in accordance with this embodiment. FIG. 2 shows front panel 2 upside down from that shown in FIG. 1. As shown in FIG. 2, display electrode 6 formed of scan electrode 4 and sustain electrode 5 is patterned on front glass substrate 3 manufactured by the float method. Lightproof layer 7 is also patterned together with display electrode 6 on substrate 3. Scan electrode 4 and sustain electrode 5 are respectively formed of transparent electrodes 4a, 5a made of indium tin oxide (ITO) or tin oxide (SnO₂), and metal bus electrodes 4b, 5b formed on transparent electrodes 4a, 5a. Metal bus electrodes 4b, 5b give electrical conductivity to transparent electrodes 4a, 5a along the longitudinal direction of electrodes 4a, 5a, and they are made of conductive material of which chief ingredient is silver (Ag).

Dielectric layer 8 is formed of at least two layers, i.e. first dielectric layer 81 that covers transparent electrodes 4a, 5a and metal bus electrodes 4b, 5b and light proof layer 7 formed on front glass substrate 3, and second dielectric layer 82 formed on first dielectric layer 81. On top of that, protective layer 9 is formed on second dielectric layer 82.

Next, a method of manufacturing PDP 1 is demonstrated hereinafter. First, form scan electrodes 4, sustain electrodes 5, and lightproof layer 7 on front glass substrate 3. Scan electrode 4 and sustain electrode 5 are respectively formed of transparent electrodes 4a, 5a and metal bus electrodes 4b, 5b. These transparent electrodes 4a, 5a, and metal bus electrodes 4b, 5b are patterned with a photo-lithography method. Transparent electrodes 4a, 5a are formed by using a thin-film process, and metal bus electrodes 4b, 5b are made by firing the paste containing silver (Ag) at a given temperature before the paste is hardened. Light proof layer 7 is made by screen-printing the paste containing black pigment, or by forming the black pigment on the entire surface of the glass substrate, and then patterning the pigment with the photolithography method before the paste is fired.

Next, apply dielectric paste onto front glass substrate 3 with a die-coating method such that the paste can cover scan electrodes 4, sustain electrodes 5, and lightproof layer 7, thereby forming a dielectric paste layer (dielectric material layer, not shown). Then leave front glass substrate 3, on which dielectric paste is applied, for a given time as it is, so that the surface of the dielectric paste is leveled to be flat. Then fire and harden the dielectric paste layer for forming dielectric layer 8 which covers scan electrodes 4, sustain electrodes 5 and lightproof layer 7. The dielectric paste is a kind of paint containing binder, solvent, and dielectric material such as glass powder.

Next, form protective layer 9 made of magnesium oxide (MgO) on dielectric layer 8 by the vacuum deposition method. The foregoing steps allow forming predetermined structural elements (scan electrodes 4, sustain electrodes 5, lightproof layer 7, dielectric layer 8 and protective layer 9) on front glass substrate 3, so that front panel 2 is completed.

Rear panel 10 is formed this way: First, form a material layer, which is a structural element of address electrode 12, by screen-printing the paste containing silver (Ag) onto rear glass substrate 11, or by patterning with the photolithography method a metal film which is formed in advance on the entire surface of rear glass substrate 11. Then fire the material layer at a given temperature, thereby forming address electrode 12. Next, form a dielectric paste layer (not shown) on rear glass substrate 11, on which address electrodes 12 are formed, by applying dielectric paste onto substrate 11 with the die-coating method such that the dielectric paste layer can cover address electrodes 12. Then fire the dielectric paste layer for forming primary dielectric layer 13. The dielectric paste is formed of paint containing dielectric material such as glass powder, binder, and solvent.

Next, apply the paste containing the material for barrier rib onto primary dielectric layer 13, and pattern the paste into a given shape, thereby forming a barrier-rib material layer. Then fire this barrier-rib material layer for forming barrier ribs 14. The photolithography method or a sand-blasting method can be used for patterning the paste applied onto primary dielectric layer 13. Next, apply the phosphor paste containing phosphor material onto primary dielectric layer 13 surrounded by barrier ribs 14 adjacent to one another and also onto lateral walls of barrier ribs 14. Then fire the phosphor paste for forming phosphor layer 15. The foregoing steps allow completely forming rear panel 10 including the predetermined structural elements on rear glass substrate 11.

Front panel 2 and rear panel 10 discussed above are placed confronting each other such that scan electrodes 4 intersect at right angles with address electrodes 12, and the peripheries of panel 2 and panel 10 are sealed with glass frit to form discharge space 16 therebetween, and space 16 is filled with discharge gas including Ne, Xe. PDP 1 is thus completed.

First dielectric layer 81 and second dielectric layer 82 forming dielectric layer 8 of front panel 2 are detailed hereinafter. The dielectric material of first dielectric layer 81 is formed of the following compositions, bismuth oxide (Bi₂O₃) in 20-40 wt %; at least one composition in 0.5-12 wt % selected from the group consisting of calcium oxide (CaO), strontium oxide (SrO), and barium oxide (BaO); and at least one composition in 0.1-7 wt % selected from the group consisting of molybdenum oxide (MoO₃), tungstic oxide (WO₃), cerium oxide (CeO₂), and manganese dioxide (MnO₂).

At least one composition in 0.1-7 wt % selected from the group consisting of copper oxide (CuO), chromium oxide (Cr₂O₃), cobalt oxide (Co₂O₃), vanadium oxide (V₂O₇), and antimony oxide (Sb₂O₃) can replace the foregoing molybdenum oxide (MoO₃), tungstic oxide (WO₃), and cerium oxide (CeO₂), manganese dioxide (MnO₂).

Other than the foregoing compositions, the following compositions free from lead (Pb) can be contained: zinc oxide (ZnO) in 0-40 wt %; boron oxide (B₂O₃) in 0-35 wt %; silicon dioxide (SiO₂) in 0-15 wt %, and aluminum oxide (Al₂O₃) in 0-10 wt %. The contents of the foregoing material compositions are not specifically specified, but they can fall within the range of the contents conventionally used.

The dielectric material containing the foregoing compositions is grinded by a wet jet mill or a ball mill into powder such that an average particle diameter of the powder can fall within the range from 0.5 μm to 2.5 μm. Next, this dielectric powder in 55-70 wt % and binder component in 30-45 wt % are mixed with a three-roll mill, so that the paste for the first dielectric layer to be used in the die-coating or the printing can be produced.

The binder component is formed of terpinol or butyl carbitol acetate which contains ethyl-cellulose or acrylic resin in 1 wt %-20 wt %. The paste can contain, upon necessity, plasticizer such as dioctyl phthalate, dibutyl phthalate, triphenyl phosphate, tributyl phosphate, and dispersant such as glycerop mono-oleate, sorbitan sesquio-leate, homogenol (a product manufactured by Kao Corporation) alkyl-allyl based phosphate for improving the printing performance.

Next, the paste for the first dielectric layer discussed above is applied to front glass substrate 3 with the die-coating method or the screen-printing method such that the paste covers display electrodes 6, before the paste is dried. The paste is then fired at 575-590° C. a little bit higher than the softening point of the dielectric material.

Second dielectric layer 82 is detailed hereinafter. The dielectric material of second dielectric layer 82 is formed of the following compositions: bismuth oxide (Bi₂O₃) in 11-20 wt %; at least one composition in 1.6-21 wt % selected from the group consisting of calcium oxide (CaO), strontium oxide (SrO), and barium oxide (BaO); and at least one composition in 0.1-7 wt % selected from the group consisting of molybdenum oxide (MoO₃), tungstic oxide (WO₃), and cerium oxide (CeO₂).

At least one composition in 0.1-7 wt % selected from the group consisting of copper oxide (CuO), chromium oxide (Cr₂O₃), cobalt oxide (Co₂O₃), vanadium oxide (V₂O₇), antimony oxide (Sb₂O₃), and manganese dioxide (MnO₂) can replace the foregoing molybdenum oxide (MoO₃), tungstic oxide (WO₃), and cerium oxide (CeO₂).

Other than the foregoing compositions, the following compositions free from lead (Pb) can be contained: zinc oxide (ZnO) in 0-40 wt %; boron oxide (B₂O₃) in 0-35 wt %; silicon dioxide (SiO₂) in 0-15 wt %, and aluminum oxide (Al₂O₃) in 0-10 wt %. The contents of the foregoing material compositions are not specifically specified, but they can fall within the range of the contents conventionally used.

The dielectric material containing the foregoing compositions is grinded by the wet jet mill or the ball mill into powder such that an average particle diameter can fall within the range from 0.5 μm to 2.5 μm. Next, this dielectric powder in 55-70 wt % and binder component in 30-45 wt % are mixed with a three-roll mill, so that the paste for the second dielectric layer to be used in the die-coating or the printing can be produced. The binder component is formed of terpinol or butyl carbitol acetate which contains ethyl-cellulose or acrylic resin in 1 wt %-20 wt %. The paste can contain, upon necessity, plasticizer such as dioctyl phthalate, dibutyl phthalate, triphenyl phosphate, tributyl phosphate, and dispersant such as glycerop mono-oleate, sorbitan sesquio-leate, homogenol (product manufactured by Kao Corporation), alkyl-allyl based phosphate for improving the printing performance.

Then the paste of the second dielectric layer discussed above is applied onto first dielectric layer 81 with the die-coating method or the screen-printing method before the paste is dried. The paste is then fired at 550-590° C. a little bit higher than the softening point of the dielectric material.

The film thickness of dielectric layer 8 (total thickness of first layer 81 and second layer 82) is preferably not greater than 41 μm in order to maintain the visible light transmission. First dielectric layer 81 contains a greater amount (20-40 wt %) of bismuth oxide (Bi₂O₃) than second dielectric layer 82 in order to suppress the reaction of layer 81 with silver (Ag) of metal bus electrodes 4b, 5b, so that first layer 81 is obliged to have a visible light transmittance lower than that of second layer 82. To overcome this problem, first layer 81 is formed thinner than second layer 82.

If second dielectric layer 82 contains bismuth oxide (Bi₂O₃) not greater than 11 wt %, it resists to be colored; however, air bubbles tend to occur in second layer 82, so that the content of bismuth oxide (Bi₂O₃) less than 11 wt % is not desirable. On the other hand, if the content exceeds 40 wt %, second layer 82 tends to be colored, so that the content of bismuth oxide (Bi₂O₃) over 40 wt % is not favorable for increasing the visible light transmittance.

A brightness of PDP advantageously increases and a discharge voltage also advantageously lowers at a less thickness of dielectric layer 8, so that the thickness of layer 8 is desirably set as thin as possible insofar as the dielectric voltage is not lowered. Considering these conditions, the thickness of dielectric layer 8 is set not greater than 41 μm in this embodiment. To be more specific, first dielectric layer 81 has a thickness ranging from 5 to 15 μm and second dielectric layer 82 has a thickness ranging from 20 to 36 μm.

The PDP thus manufactured encounters little coloring (yellowing) in front glass substrate 3 although display electrodes 6 are formed of silver (Ag), and yet, its dielectric layer 8 has no air bubbles, so that dielectric layer 8 excellent in withstanding voltage performance is achievable.

The dielectric materials discussed above allows first dielectric layer 81 to have less yellowing or air bubbles. The reason is discussed hereinafter. It is known that the addition of molybdenum oxide (MoO₃) or tungstic oxide (WO₃) to the dielectric glass containing bismuth oxide (Bi₂O₃) tends to produce such chemical compounds at a temperature as low as 580° C. or lower than 580° C. as Ag₂MoO₄, Ag₂Mo₂O₇, Ag₂Mo₄O₁₃, Ag₂WO₄, Ag₂W₂O₇, Ag₂W₄O₁₃.

Since dielectric layer 8 is fired at a temperature between 550° C. and 590° C. in this embodiment, silver ions (Ag+) diffused in dielectric layer 8 during the firing react with molybdenum oxide (MoO₃), tungstic oxide (WO₃), cerium oxide (CeO₂), or manganese oxide (MnO₂) contained in dielectric layer 8, thereby producing a stable chemical compound. In other words, silver ions (Ag+) are stabilized without having undergone the reduction, so that the silver ions are not aggregated, nor form colloid. A smaller amount of oxygen is thus produced because the colloid formation accompanies the oxygen production. As a result, the smaller amount of air bubbles is produced in dielectric layer 8.

To use the foregoing advantage more effectively, it is preferable for the dielectric glass containing the bismuth oxide (Bi₂O₃) to contain molybdenum oxide (MoO₃), tungstic oxide (WO₃), cerium oxide (CeO₂), or manganese oxide (MnO₂) at a content not less than 0.1 wt %, and it is more preferable that the content should be in the range from not smaller than 0.1 wt % to not greater than 7 wt %. The content less than 0.1 wt % will reduce the yellowing in only little amount, and the content over 7 wt % will produce coloring to the glass, so that the content out of the foregoing range is not desirable.

To be more specific, first dielectric layer 81 adjacent to metal bus electrodes 4b, 5b made of silver (Ag) can reduce the yellowing and the air-bubbles, and second dielectric layer 82 placed on first dielectric layer 81 allows the light to transmit at a higher light transmittance. As a result, dielectric layer 8 as a whole allows the PDP to encounter both of the air bubbles and the yellowing in extremely smaller amounts, and yet, allows the PDP to have the higher light transmittance.

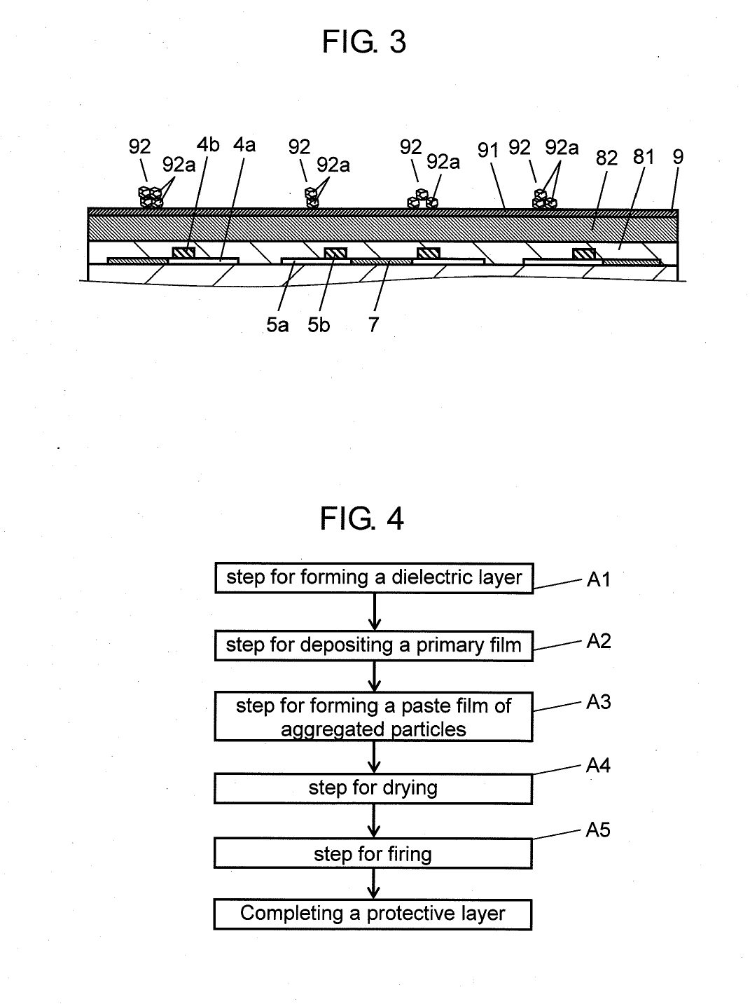

The structure and the manufacturing method of protective layer 9 of the present invention are detailed hereinafter. FIG. 3 shows a sectional view detailing protective layer 9. As shown in FIGS. 2 and 3, protective layer 9 of the PDP in accordance with this embodiment is formed this way: primary film 91, made of magnesium oxide (MgO) or MgO containing aluminum (Al) as impurity, is formed on dielectric layer 8, and aggregated particles 92 are dispersed uniformly and discretely on the entire surface of this primary film 91. Aggregated particle 92 is formed by aggregating several crystal particles 92a made of metal oxide, i.e. MgO.

The manufacturing steps for protective layer 9 of the PDP in accordance with this embodiment are further detailed hereinafter. FIG. 4 shows a flowchart illustrating the method for manufacturing the protective layer of the PDP. As shown in FIG. 4, step A1 is done for forming dielectric layer 8 by layering first dielectric layer 81 and second dielectric layer 82 together, and then step A2 is done for depositing primary film 91 made of MgO on second dielectric layer 82 of dielectric layer 8 with a vacuum deposition method by using sintered body.

Then attach discretely multiple aggregated particles 92 onto primary film 91, which is formed in step A2 for depositing the primary film and is not fired yet. In this step, firstly prepare the paste of aggregated particles formed by mixing aggregated particles 92 having a given particle-size distribution with resin component into solvent, and then, in step A3, spray this paste onto non-fired primary film 91 with a screen printing method for forming the film of aggregated particle paste. Instead of the screen printing method, a spraying method, spin-coating method, die-coating method, or slit-coating method can be used for spraying this paste on non-fired primary film 91 to form the film of aggregated particle paste.

After the formation of the paste film of aggregated particles, the paste film undergoes drying step A4. Then primary film 91 not yet fired and the paste film having undergone drying step A4 are fired together at several hundreds ° C. in firing step A5. In step A5, solvent and resin component remaining in the paste film are removed, and primary film 91 is fired to be attached with multiple aggregated particles 92 for forming protective layer 9.

This method allows multiple aggregated particles 92 to be distributed and attached uniformly onto the entire surface of primary film 91. There are other method than the method discussed above, for instance, blasting groups of the particles directly to primary film 91 without using the solvent, or spraying the particles simply relying on gravity.

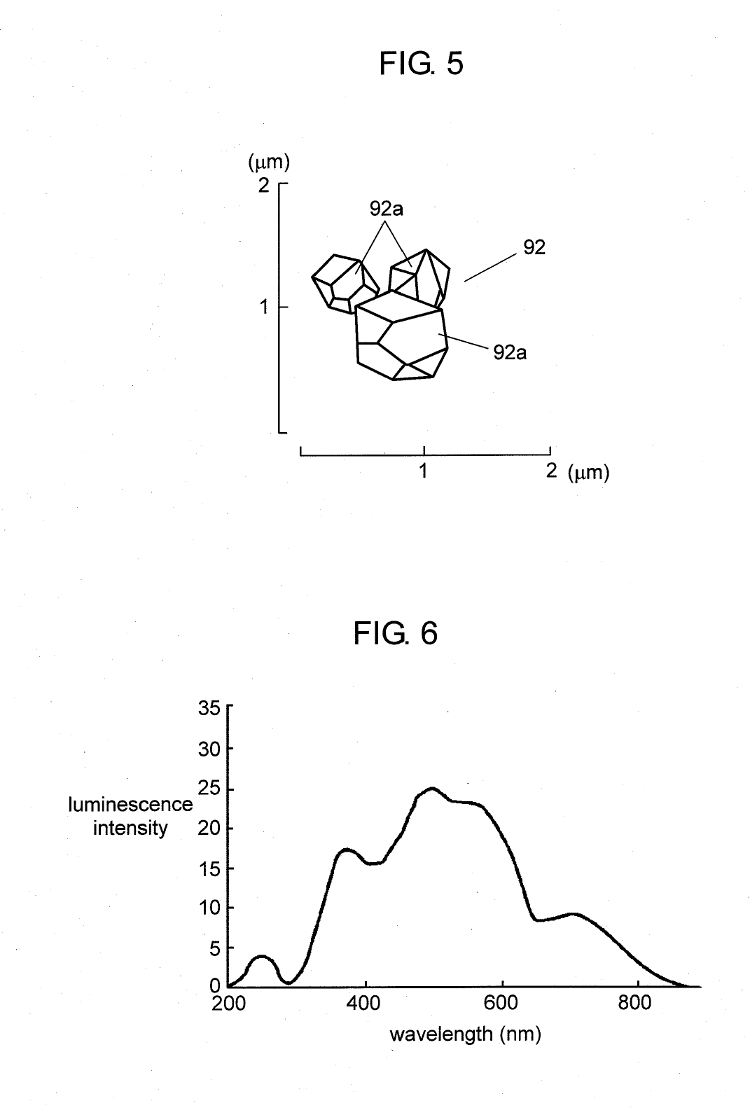

FIG. 5 details aggregated particle 92, which is formed, as shown in FIG. 4, by aggregating or necking crystal particles 92a, i.e. primary particles having a given size, and aggregated particles 92 is not bonded together like a solid body with great bonding force, but the multiple primary particles simply form an aggregate with static electricity or van der Waals force. Thus parts of or all of the aggregated particle 92 gather one another as weak as they turned into primary particles by external stimulus, such as an ultrasonic wave, thereby bonding together to form the aggregated particle 92. The particle diameter of aggregated particle 92 is approx. 1 μm, and crystal particle 92a desirably forms a polyhedral shape having seven faces or more than seven faces such as 14 faces or 12 faces.

Crystal particle 92a, made of MgO, used in the present invention is formed by firing the precursor of anyone of metallic carbonation, metallic hydroxide, or metallic chloride of magnesium carbonate or magnesium hydroxide. The particle diameter of the primary particle can be controlled by a manufacturing condition of crystal particles 92a. For instance, when crystal particles 92a are formed by firing the precursor of magnesium carbonate or magnesium hydroxide, the firing temperature or the firing atmosphere is controlled, whereby the particle diameter can be controlled. In general, the firing temperature can be selected from the range of 700-1500° C. A rather higher firing temperature over 1000° C. allows the diameter of the primary particle to fall within the range of 0.3-2 μm. Crystal particle 92a can be obtained by heating the foregoing precursor, and during its production steps, multiple primary particles are bonded together by the phenomenon called necking or aggregation, whereby aggregated particle 92 can be obtained.

The inventors made the following experiments with the advantages of the PDP having the protective layer discussed above: First, prepare several PDPs having the protective layer differently structured. Sample 1 is a PDP of which protective layer is formed of only primary film 91 made of MgO. Sample 2 is a PDP of which protective layer is formed of only primary film 91 made of MgO into which impurity such as Al or Si is doped. Sample 3 is a PDP of which protective layer is formed of primary film 91 made of MgO, on which only primary particles of crystal particles made of metal oxide are sprayed and attached. Sample 4 is PDP 1 in accordance with the embodiment of the present invention. This PDP 1 includes protective layer 9 having primary film 91 made of MgO, and aggregated particles 92 formed by aggregating multiple crystal particles 92a are uniformly distributed and attached on the entire surface of film 91. Samples 3 and 4 employ single crystal particles made of metal oxide, namely, magnesium oxide (MgO). Cathode luminescence of the single crystal particle employed in sample 4 is measured to find the characteristics as shown in FIG. 6. Those four PDP samples are tested for the electron emission performance and the electric charge retention performance.

The electron emission performance is a numerical value, i.e. a greater value indicates a greater amount of electron emitted, and is expressed with an amount of primary electron emitted, which is determined by a surface condition of protective layer 9 and a type of gas. The amount of primary electron emitted can be measured with a method that is used for measuring an amount of electron current emitted from the surface of protective layer 9 through irradiating the surface with ions or an electron beam. However, it is difficult to test the surface of front panel 2 of PDP 1 with a non-destructive examination. The evaluation method disclosed in Unexamined Japanese Patent Publication No. 2007-48733 is employed to measure a discharge delay (“ts” value) as the electron emission performance. In other words, a statistical delay time, which is a reference to the easiness of discharge occurrence, among delay times in discharge is measured. This reference number is inversed, and then integrated, thereby obtaining a value which linearly corresponds to the amount of emitted primary electrons, so that the value is used for the evaluation. The delay time in discharge expresses the time of discharge delay (hereinafter referred to as “ts” value) from the pulse rising, and the discharge delay is chiefly caused by the struggle of the initial electrons, which trigger off the discharge, for emitting from the surface of the protective layer into the discharge space.

The electric charge retention performance is expressed with a voltage value applied to scan electrodes (hereinafter referred to as a “Vscn” lighting voltage), to be more specific, higher electric charge retention performance can be expected at a lower Vscn lighting voltage, so that a lower Vscn voltage allows the PDP to be driven at a lower voltage design-wise. As a result, the power supply and electric components with a smaller withstanding voltage and a smaller capacity can be employed. In the existing products, semiconductor switching elements such as MOSFET are used for applying sequentially a scan voltage, and these switching elements have approx. 150V as a withstanding voltage. The Vscn lighting voltage is thus preferably lowered to not greater than 120V in the environment of 70° C. taking it into consideration that some change can occur due to temperature variation.

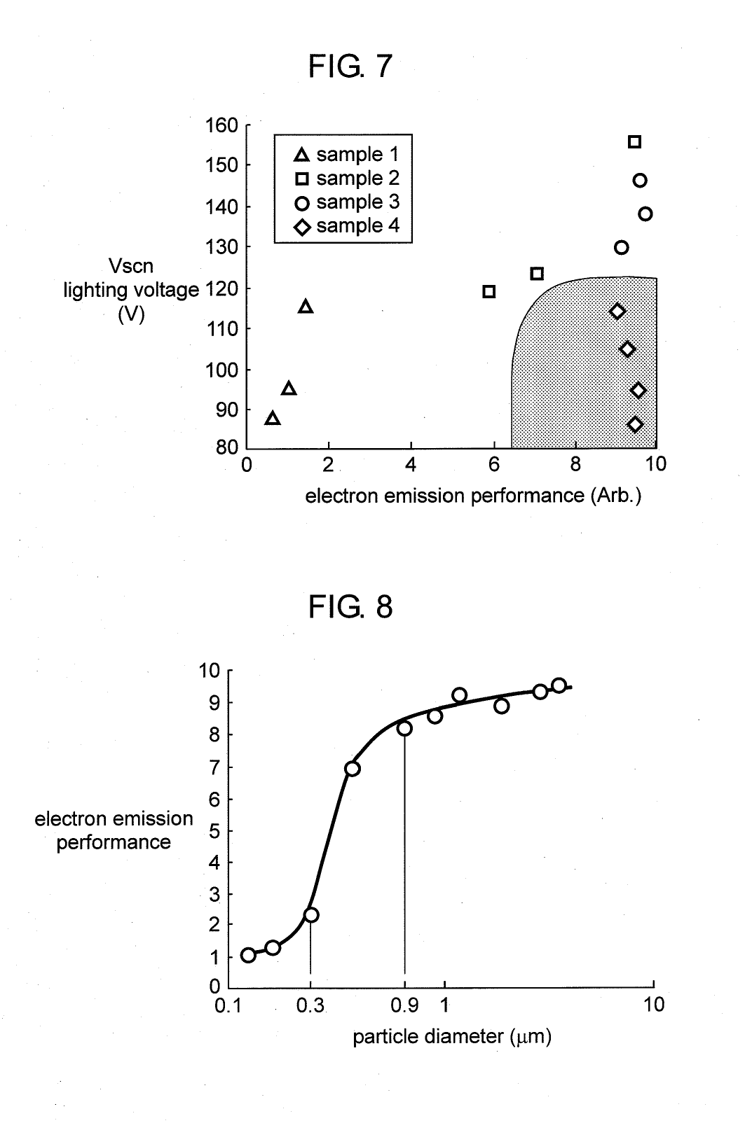

FIG. 7 shows relations between the electron emission characteristics and the Vscn lighting voltage of PDPs, and it shows the comparison between test results of samples 1-3 and the test result of the PDP in accordance with this embodiment. As discussed above, sample 1 includes the protective layer employing only the primary film made of MgO, and the test result of this sample 1 is taken as a reference value, and the test results of the others are expressed as relative values to the reference value. As FIG. 7 explicitly depicts, sample 4, which is the PDP in accordance with this embodiment, can achieve controlling Vscn lighting voltage to be not greater than 120V in the electric charge retention test, and yet, it can achieve approx. six times as good as sample 1 in the electron emission performance.

In general, the electron emission capability and the electric charge retention capability of the protective layer of PDP conflict with each other. For instance, a change in film forming condition of the protective layer, or doping an impurity such as Al, Si, or Ba into the protective layer during the film forming process, will improve the electron emission performance; however, the change or the doping will raise the Vscn lighting voltage as a side effect.

PDP 1 having protective layer 9 of the present invention allows obtaining the electron emission capability not smaller than 6 and the electric charge retention capability not greater than 120V of Vscn lighting voltage. Protective layer 9 thus can satisfy both of the electron emission capability and the electric charge retention capability appropriately to the PDP which is required to display an increased number of scanning lines as well as to have the smaller size cells due to the advent of high definition TV.

Next, a particle diameter of crystal particle 92a employed in protective layer 9 of PDP 1 of the present invention is described hereinafter. The particle diameter refers to an average particle diameter, which means a volume cumulative average diameter (D50).

FIG. 8 shows a test result of sample 4 described in FIG. 7, and the test is done for the electron emission performance by changing a particle diameter of crystal particle 92a of MgO. The particle diameter of MgO is measured by observing crystal particles 92a in SEM photo. As shown in FIG. 8, the particle diameter as small as 0.3 μm results in the lower electron emission performance, while the particle diameter as great as 0.9 μm or more results in the higher electron emission performance.

A greater number of crystal particles per unit area on protective layer 9 is preferable for increasing the number of emitted electrons within a discharge cell. However, presence of crystal particles 92a at the top of barrier rib 14, with which protective layer 9 of front panel 2 closely contacts, breaks the top of barrier rib 14, and then the material of rib 14 accumulates on phosphor layer 15, so that the cell encountering this problem cannot normally turn on or off. This breakage in the barrier ribs resists occurring when crystal particle 92a does not exist at the top of barrier rib 14, so that a greater number of crystal particles 92a will increase the occurrence of breakage in barrier ribs 14.

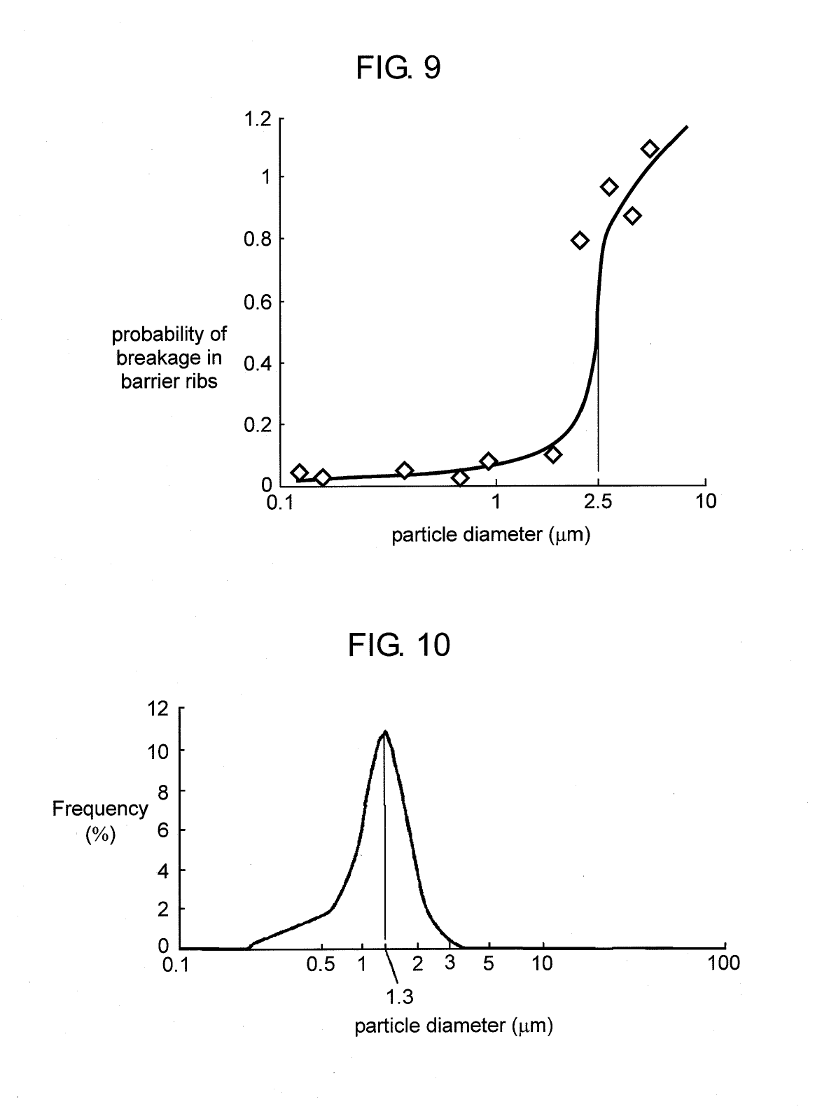

FIG. 9 shows relations between the particle diameter of crystal particle 92a and the breakage in barrier rib 14. The same numbers of crystal particles 92a per unit area although they have different diameters are sprayed, and a rate of occurrence (probability) of the breakage in the barrier ribs at a particle diameter of 5 μm is taken as a reference.

As FIG. 9 explicitly depicts, the probability of breakage in barrier ribs 14 sharply increases when the diameter of crystal particle 92a grows as large as 2.5 μm; however, it stays at a rather low level when the diameter stays not greater than 2.5 μm. The result tells that aggregated particle 92 preferably has a particle diameter within a range from 0.9 μm to 2.5 μm. However, it is necessary to consider a dispersion of crystal particles in manufacturing and a dispersion of protective layers in manufacturing.

FIG. 10 shows an instance of particle size distribution of aggregated particle 92 employed in PDP 1. Although aggregated particle 92 has the particle size distribution as shown in FIG. 10, the electron emission characteristics shown in FIG. 8 and barrier-rib breakage characteristics shown in FIG. 9 teach that it is preferable to use the aggregated particles, of which average particle diameter, i.e. volume cumulative average diameter (D50), falls within a range from 0.9 μm to 2 μm.

As discussed above, the PDP having the protective layer of the present invention achieves electron emission capability more than six times as good as a protective layer formed of only primary film made of MgO, and also achieves electric charge retention capability that controls the Vscn lighting voltage to be not greater than 120V. As a result, the PDP thus can satisfy both of the electron emission capability and the electric charge retention capability, although the PDP is to display an increased number of scanning lines as well as to have the smaller size cells due to the advent of high definition TV. The PDP which can display a high definition video with high luminance at lower power consumption is thus obtainable.

In the foregoing discussion, magnesium oxide (MgO) is taken as an example of the protective layer; however, the primary film must withstand intensive sputtering because it should protect the dielectric material from ion-impact. A conventional PDP employs a protective layer formed of only a primary film chiefly made of MgO in order to satisfy both of the electron emission performance and withstanding performance to the sputtering at a certain level or higher than the certain level. The PDP of the present invention, however, employs the primary film attached with metal oxide on the film, and crystal particles of the metal oxide dominantly control the electron emission performance. The primary film, therefore, is not necessarily made of MgO, but other materials more excellent in resistance to sputtering, such as Al₂O₃, can replace MgO.

In this embodiment, MgO particles are used as single crystal particles; however, other single crystal particles of metal oxide such as strontium (Sr), calcium (Ca), barium (Ba), and aluminum (Al) as long as they have the electron emission performance as high as MgO can replace MgO. Use of these metal oxides can also achieve similar advantages to the foregoing ones. The single crystal particle is thus not limited to MgO. In the case of employing the crystal particles of the metal oxides such as Sr, Ca, Ba, and Al, the precursor of anyone of metallic carbonation, metallic hydroxide, or metallic chloride of Sr, Ca, Ba, and Al is fired to produce the crystal particles, and then multiple crystal particles are aggregated into an aggregated particle.

### INDUSTRIAL APPLICABILITY

The present invention is useful for obtaining a PDP which has display performance of high definition and high luminance at lower power consumption.

1. A plasma display panel (PDP) comprising:
a front panel including a dielectric layer for covering display electrodes formed on a substrate, and a protective layer formed on the dielectric layer; and
a rear panel confronting the front panel for forming a discharge space between the front panel and the rear panel, and including address electrodes along a direction intersecting with the display electrodes, and barrier ribs for partitioning the discharge space,
wherein the protective layer includes a primary film on the dielectric layer, and aggregated particles, each of which is formed of a plurality of crystal particles made by firing a precursor of metal oxide, are distributed and attached on an entire surface of the primary film.

2. The PDP of claim 1, wherein the precursor of the metal oxide is one of metallic carbonation, metallic hydroxide, and metallic chloride.

3. The PDP of claim 1, wherein the aggregated particle has an average particle diameter falling within a range from 0.9 μm to 2 μm.

4. The PDP of claim 1, wherein the primary film is made of magnesium oxide.
